(19) United States
(12) Patent Application Publication
(10) Pub. No.: US 2013/0008262 A1
(43) Pub. Date: Jan. 10, 2013

(54) Volumetric Gas Flow Meter With Automatic Compressibility Factor Correction

(76) Inventors: Edward Albert Morrell, Randolph, NJ (US); David William Wilson, Budd Lake, NJ (US); Mohammed Abdul Aziz, Clifton, NJ (US)

(21) Appl. No.: 13/536,742

(22) Filed: Jun. 28, 2012

Related U.S. Application Data
(60) Provisional application No. 61/501,856, filed on Jun. 28, 2011.

(51) Int. Cl. G01F 1/56

(52) U.S. Cl. 73/861.08

(57) ABSTRACT

A method and a gas flow meter for measuring gas flow, having a cylinder, and a piston disposed movably within the cylinder, forming a clearance seal between the piston and the cylinder. A gas flow to be measured is directed to the cylinder so as to move the piston within the cylinder. From the detected movement of the piston, electrical signals representative of the gas flow are generated. Gas temperature and pressure data are also measured. A controller calculates a standardized flow rate of gas based on gas species information, and determines a compressibility factor based on the gas species information and the temperature and pressure data, and calculates a corrected flow rate. The compressibility factor is determined from a table pre-stored in a memory.

### CROSS-REFERENCE TO RELATED APPLICATION

This application claims priority to Provisional Application No. 61/501,856 filed Jun. 28, 2011, and application Ser. No. 13/530,968 filed Jun. 22, 2012, both incorporated by reference.

### BACKGROUND OF THE INVENTION

The present invention relates to a high accuracy positive displacement gas flow meter.

In one aspect, the flow meter may have a controller implementing a method of measuring gas flow, including automatic compressibility factor correction.

In another aspect, the flow meter may have horizontal piston movement. The flow meter may advantageously have a low mass piston, constructed of a rigid material such as glass or graphite. Advantageously, a low friction film outer coating of wear resistant material such as diamond-like carbon (DLC) may be formed on the piston.

Positive displacement piston flow meter technology is well established. A piston is fitted precisely into a cylinder with a clearance in the range of up to about 10 microns. Flow introduced into the cylinder displaces the piston. The time required to displace the piston a known distance is used to measure the flow rate. See for example U.S. Pat. No. 5,440,925, incorporated by reference. Known flow meters of this type have pistons constructed of various materials such as glass or graphite. The piston is fitted into a cylinder, commonly made of glass, which is typically oriented vertically to minimize piston wear.

An improved flow meter, described in application Ser. No. 13/530,968 filed Jun. 22, 2012, has a low mass piston, optionally but advantageously with a low-friction coating, arranged in a horizontal cylinder. Flow is introduced into the cylinder under the control of valves. The piston is displaced a known distance in the cylinder to make a measurement, and then the valves reverse the flow to displace the piston in the opposite direction to make the next measurement.

As used herein, the term “cylinder” includes not merely a cylinder with a circular cross-section, but also any other regular geometric solid shape adapted to receive a correspondingly-shaped piston for flow measurement according to the principles described herein.

As used herein, the term “horizontal” indicates merely that the cylinder is sufficiently horizontal to obtain satisfactory flow measurements.

A gas flow meter according to these principles may comprise the following: a support portion for supporting the flow meter on an external structure; a cylinder supported in the flow meter to be held in a horizontal orientation when the flow meter is supported on the external structure; a piston movable within the cylinder, the piston having a surface which forms a clearance seal with a surface of the cylinder; a gas inlet for receiving a gas flow to be measured, and valving for directing the flow to the cylinder so as to move the piston within the cylinder; and a movement detector for detecting movement of the piston and generating therefrom electrical signals representative of the gas flow to be measured. The piston may have a low-friction coating. The piston oscillates between two piston measurement detectors and the time interval required for the piston to sweep the calibrated tube volume provides the volumetric flow rate. The support portion may be a base of the flow meter, configured for resting on the external surface, and the cylinder may be supported substantially parallel to the base. There may also be a leveling device at the base for adjusting the horizontal orientation of the cylinder. The valving may comprise first valves for directing the gas flow to a first end of the cylinder for moving the piston in a first direction, and second valves for directing the gas flow to a second end of the cylinder for moving the piston in a second direction. When a gas flow measurement is initiated, two normally closed valves for the selected tube open and four flow control valves operate, directing the gas flow. Different valve arrangements are of course possible.

Also included is a control unit which controls the valves to alternately direct the gas flow to the first end and to the second end of the cylinder, and to process the electrical signals and thereby output the measurement of the gas flow in the first and second directions.

However, gas is compressible and gas volume will change as the gas temperature or gas pressure changes. Compressibility of gas for a hypothetical ideal gas is defined by the ideal gas law equation of state PV=nRT, where:

P is the absolute pressure of the gas

V is the volume of gas

n is the number of moles of the given gas

R is the universal gas constant

T is the absolute temperature of the gas

Since gas changes volume with temperature and pressure, gas flow is commonly reported under a set of standard conditions of temperature and pressure (standardized flow). Pressure is preferably standardized at 760 mmHg. Temperature is commonly standardized at 0° C., 20° C. or 21.1° C. Standardization temperature may be selected by the user. The definition of standardized flow is the volume of gas transported per unit time across a boundary with the measured gas volume converted to the volume the gas would occupy at a defined pressure and temperature. To do this the temperature and pressure of the volume of gas must be measured with the volume of gas.

Under typical measurement conditions with non-reactive or inert gases, the ideal gas law provides a good model and the compressibility factor Z can be ignored. However, with non-ideal gases ignoring the compressibility factor introduces an error in the standardization calculation.

### SUMMARY OF THE INVENTION

Accordingly, the present invention provides a volumetric gas flow meter with automatic compressibility factor correction. Volumetric gas flow meters measure volumetric flow rate, defined as the volume of gas being transported across a boundary per unit time, i.e., liters/minute, cubic feet/hour, etc.

To account for the molecular behavior of real gases a compressibility factor Z is added to the ideal gas law to give PV=ZnRT. The compressibility factor Z is a function of gas species, temperature and pressure.

A temperature transducer located at the gas stream entrance to the measurement cylinder measures gas temperature. A precision pressure sensor measures gas pressure in the measurement cylinder. From the gas temperature, gas pressure and a compressibility factor the volumetric gas flow rate is converted to a standardized gas flow rate. Compressibility factor is a small correction factor applied during conversion of volumetric flow to standardized flow, as required for best accuracy when measuring reactive gases. To apply compressibility factor correction the user selects the gas species being measured from a table of gases in the memory. The compressibility factors may be previously obtained from the NIST database of gas properties REFPROP 9.0 and stored in the memory.

Standardized flow can be mathematically obtained by applying this formula derived from the ideal gas law:

Volume (standard conditions)=(Volume as measured)×(Pₘ/Pₛ)×(Tₛ/Tₘ)

### Where:

Pₘ is the measured pressure of the gas
Pₛ is the standardization pressure
Tₘ is the measured temperature of the gas
Tₛ is the standardization temperature

Many gases, however, do not behave as ideal gases and to correct for this the gas compressibility factor must be considered. To do this the gas species, gas temperature, and gas pressure must be known and the correction factor would be:

Correction Factor=Z(Tₛ,Pₛ)/Z(Tₘ,Pₘ)

### Where:

Z(Tₛ,Pₛ) is the compressibility factor for the gas under the standardizing temperature and pressure
Z(Tₘ,Pₘ) is the compressibility factor for the gas under the measured temperature and pressure

Thus, the volumetric gas flow meter automatically applies a compressibility correction factor, advantageously implemented by the controller of the flow meter with a table of factors stored in the memory. The flow meter, in addition to measuring gas volume, also measures the temperature and pressure of the gas. The user selects the species of gas being measured by the flow meter from a menu of gases and a standardization temperature. The flow meter then calculates the correction factor and applies this to the measured volume resulting in improved accuracy.

By adding corrections automatically for compressibility factor, the flow meter has improved accuracy when measuring standardized volumetric gas flow.

Other features and advantages will become apparent from the following description of embodiments, which refers to the accompanying drawings.

### BRIEF DESCRIPTION OF THE DRAWING(S)

FIG. 1 is a perspective view of a flow meter;

FIG. 2 is a schematic block diagram of the flow meter;

FIG. 3 is a side view, partly in phantom, showing a combination of a cylinder and a piston;

FIG. 4 is a flow diagram showing steps in the operation of the flow meter; and

FIG. 5 is a plan view showing layout of mechanical components.

### DETAILED DESCRIPTION OF EMBODIMENTS OF THE INVENTION

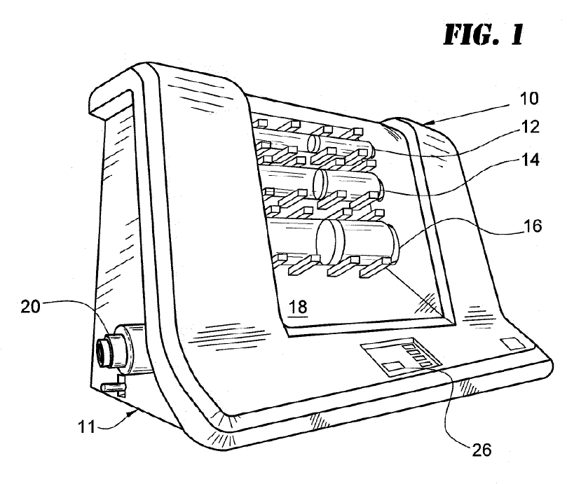

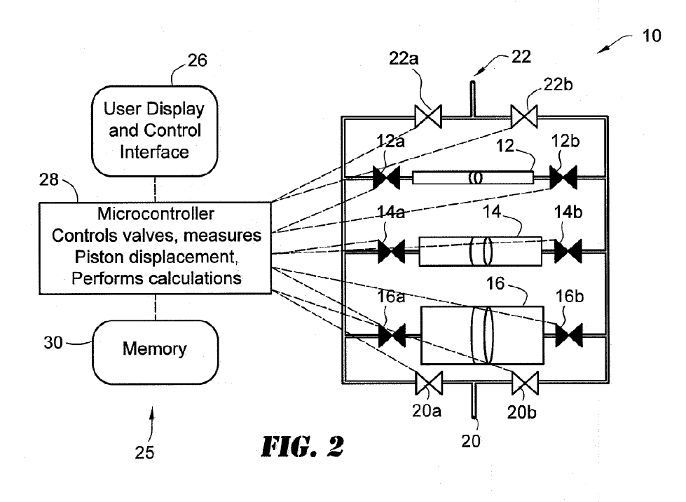

FIG. 1 is a perspective view of a flow meter 10, including three horizontal gas flow tubes 12, 14, 16 behind a viewing window 18, a pair of gas inlet/outlet ports 20, 22 (see FIG. 2), and a user interface 26 comprising an LED touch screen which accepts user inputs and reads out the flow readings.

The three gas flow tubes 12, 14 and 16 and related hardware are shown schematically in FIG. 2. A control part 25 includes the user interface 26, and a microcontroller 28 with a memory 30. The tube 12 is for low flow, for example 5 to 500 ccm. The tube 14 is for medium flow, for example 500-5000 ccm. The tube 16 is for high flow, for example 5000-50000 ccm.

In another version, the largest tube and piston (˜51 mm diameter) measures flow rates from 50,000 ccm to 3,500 ccm. The medium tube and piston (˜24 mm diameter) measures flow rates from 5,000 ccm to 350 ccm, and the smallest tube and piston (˜10 mm diameter) measures flow rates from 500 ccm to 5 ccm. The overlapping of the flow ratings between the tubes in this version allows for cross checking flow measurements with two tubes to verify instrument accuracy.

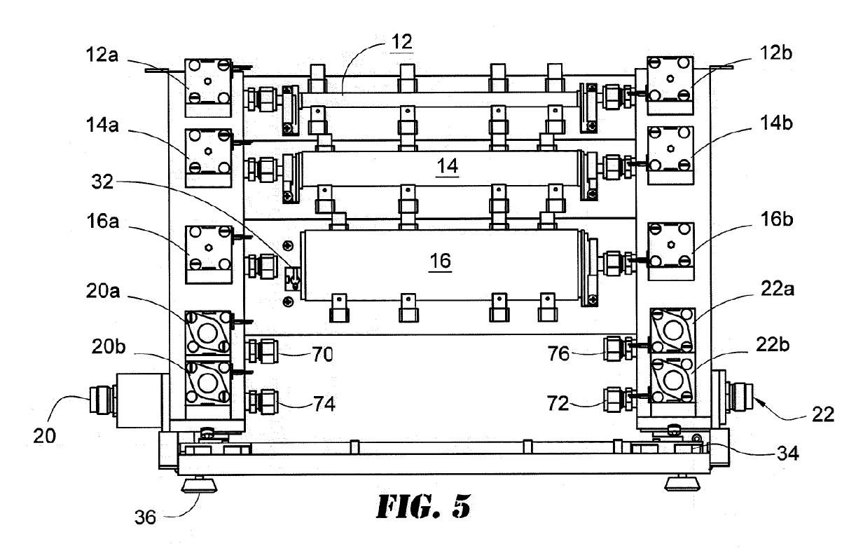

The flow meter 10 has a base 11 for resting on a work surface. The flow tubes are held in the flow meter so as to be horizontal when the flow meter is resting on the work surface. A suitable leveling device, such as an adjustable foot or feet (36 (FIG. 5), is advantageously provided at the base.

Normally-closed valves 12a, 12b, 14a, 14b, 16a, 16b can be selectively opened by the microcontroller 28 to direct gas flow through conduits to the corresponding tube 12, 14 or 16. This selection is made in response to user input or to a suitable sensor (not shown), which detects the quantity of flow to be measured and gives this information to the microcontroller 28.

Flow direction is controlled by normally-open valves 20a, 20b, 22a and 22b, connected by conduits to the valves 12a-16b. Gas flow from left to right is provided by the microcontroller 28 closing inlet valve 20b and outlet valve 22a. Gas flow from right to left is provided by closing inlet valve 20a and outlet valve 22b. These settings are alternated in order to provide gas flow measurements in both directions. This is in contrast to the known flow meters, which measure gas flow only in one direction, during the upward movement of a piston.

The normally-open and normally-closed valves can be replaced by other types of valves, with simple changes in the measuring process.

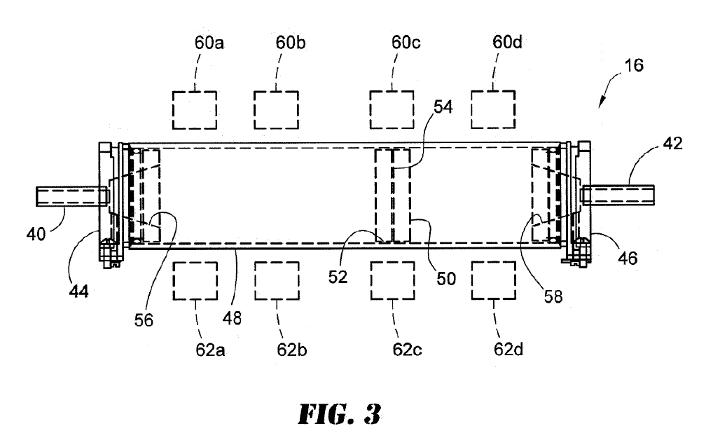

The gas flow cell 16 is shown in detail in FIG. 3, including a first inlet/outlet port 40 and a second inlet/outlet 42 mounted on respective end caps 44, 46. The end caps support respective ends of the borosilicate glass cylinder 48. The piston 50 slidably rests inside the cylinder 48 for movement to the right and left in response to gas pressure coming alternately from the ports 40 and 42, respectively. The piston 50 may be made of borosilicate glass or graphite, for example. As mentioned above, the piston 50 may have a low-friction coating, such as DLC, not shown in the figures.

As seen in FIG. 3, the piston 50 is formed as a cylinder 52 and a central web 54. The piston may be machined from a solid piece of graphite. This construction can be extremely low in mass, which is made possible by the horizontal orientation. Prior vertical flow meters needed a heavier piston, as mentioned above.

In another version, the piston may be formed of two separate pieces of glass, joined together, and advantageously with a low-friction coating. The low-friction coating would, however, be unnecessary with a graphite piston because of the self-lubricating properties of graphite on glass.

As also seen, gas enters the cylinder through passages 56, 58 formed in the end caps 44, 46.

Optical sensors 60a, b, c, d and 62a, b, c and d for sensing the piston position are shown schematically in FIG. 3. Advantageously the central sensor pairs 60b, 62b, and 60c and 62c may be used for sensing the piston timing, while the outer sensor pairs 60a, 62a and 60d, 62d may be used as safety sensors to detect abnormal movements of the piston toward the ends of the tube.

Control of the flow meter is through the user interface 26 on the front panel or through commands sent through a data port (not shown). The flow meter will auto-select the correct tube and display the flow rate.

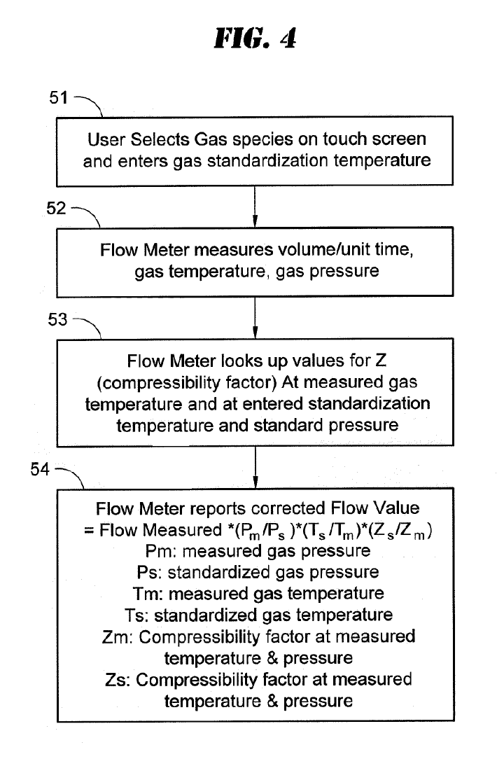

In operation, referring to FIG. 4, in a step S1, the user selects the gas species on touch screen 26 and enters gas standardization temperature.

In a step S2, the microcontroller measures volume/unit time, gas temperature, gas pressure via temperature and pressure sensors 32, 34 (FIG. 5).

In a step S3, the microcontroller 28 looks up values for Z (compressibility factor) at measured gas temperature and pressure and at entered standardization temperature and standard pressure in the memory 30.

In a step S4, the microcontroller reports corrected flow value=flow measured*(Pₘ/Pₛ)*(Tₛ/Tₘ)*(Zₛ/Zₘ), Pm: measured gas pressure, Ps: standardized gas pressure, Tm: measured gas temperature, Ts: standardized gas temperature, Zm: compressibility factor at measured temperature and pressure, Zs: compressibility factor at standardized temperature and pressure.

In more detail, for measuring standardized gas flow rates, particularly for corrosive gases such as NH₃, the ideal gas law PV=nRT does not accurately convert volumetric gas flow to standardized gas flow. To correct for non-ideal gas behavior the compressibility factor Z is included, resulting in PV=ZnRT.

Each gas species has a specific compressibility factor Z that varies with gas temperature and pressure.

The equations governing compressibility factor are as follows: Starting with the equation of state:

Z=P*V/R*T

where:
Z is the compressibility factor for the gas
P is the absolute pressure of the gas
V is the molar volume of the gas
R is the universal gas constant
T is the absolute temperature of the gas

The controller applies this equation of state to gas flow at standardized conditions and at the measured conditions, to arrive at:

Qs=Qm*(Pm/Ps*Ts/Tm*Zs/Zm)

where:

Qs—flow rate at standardized conditions

Qm—volumetric flow rate measured by the flow meter

Ts—Standardization temperature in absolute

Tm—Temperature measured by the flow meter in absolute

Ps—Standardization Pressure, absolute

Pm—Pressure measured by the flow meter

Zs—Gas compressibility at standardized temperature and pressure

Zm—Gas compressibility at measured temperature and pressure

Although the present invention has been described in relation to particular embodiments thereof, many other variations and modifications and other uses will become apparent to those skilled in the art. Therefore, the present invention is not limited by the specific disclosure herein.

What is claimed is:

1. A gas flow meter comprising:
a cylinder;
a piston movable within said cylinder, the piston having a surface which forms a clearance seal with a surface of said cylinder;
a gas inlet for receiving a gas flow to be measured, and valving for directing said flow to said cylinder so as to move said piston within said cylinder; and a movement detector for detecting movement of said piston and generating therefrom electrical signals representative of said gas flow to be measured;
a temperature sensor and a pressure sensor which measure gas temperature and pressure data at said cylinder;
a controller which receives said electrical signals and said temperature and pressure data and calculates a standardized flow rate of gas through said cylinder;
wherein said controller further receives gas species information and determines a compressibility factor based on said gas species information and said temperature and pressure data, and calculates therefrom a corrected flow rate based on said calculated standardized flow rate and on said compressibility factor.

2. A gas flow meter according to claim 1, wherein said compressibility factor is determined from a table of compressibility factors pre-stored in said memory.

3. A gas flow meter according to claim 1, wherein said controller further receives a standardization temperature as an additional basis for said corrected flow rate.

4. A gas flow meter according to claim 1, wherein said cylinder is held in a horizontal orientation in said flow meter.

5. A gas flow meter according to claim 4, wherein said valving comprises first valves for directing the gas flow to a first end of said cylinder for moving said piston in a first direction, and second valves for directing said gas flow to a second end of said cylinder for moving said piston in a second direction.

6. A gas flow meter according to claim 5, furthering comprising a control unit which controls said valves to alternately direct said gas flow to said first end and to said second end and to process said electrical signals and thereby output said measured gas flow in said first and second directions.

7. A method of measuring gas flow, comprising the steps of:
supporting a cylinder in said flow meter
disposing a piston movably within said cylinder, the piston having a surface which forms a clearance seal with a surface of said cylinder;
receiving a gas flow to be measured at a gas inlet, and directing said flow to said cylinder so as to move said piston within said cylinder; and
detecting movement of said piston and generating therefrom electrical signals representative of said gas flow to be measured;
measuring gas temperature and pressure data at said cylinder;
receiving said electrical signals and said temperature and pressure data and calculating a standardized flow rate of gas through said cylinder;
further receiving gas species information and determining a compressibility factor based on said gas species information and said temperature and pressure data, and calculating therefrom a corrected flow rate based on said calculated standardized flow rate and on said compressibility factor.

8. A method according to claim 7, further comprising the step of receiving a standardization temperature as an additional basis for said corrected flow rate.

9. A method according to claim 7, wherein said compressibility factor is determined from a table of compressibility factors pre-stored in said memory.

10. A method according to claim 7, wherein said cylinder is held in a horizontal orientation in said flow meter.

11. A method according to claim 10, wherein said directing step comprises the steps of first directing the gas flow to a first end of said cylinder for moving said piston in a first direction, and then directing the gas flow to a second end of said cylinder for moving said piston in a second direction.

12. A method according to claim 11, furthering the steps of alternately directing said gas flow to said first end and to said second end and processing said electrical signals and thereby outputting said measured gas flow in said first and second directions.
